(19) United States
(12) Patent Application Publication
(10) Pub. No.: US 2011/0187849 A1
(43) Pub. Date: Aug. 4, 2011

(54) DETECTION APPARATUS FO PARICLE ON THE GLASS

(76) Inventors: Hyunwoo Kim, Chungcheongnam-do (KR); Jinhong Park, Chungcheongnam-do (KR); Taeho Keem, Chungcheongnam-do (KR); Changha Lee, Chungcheongnam-do (KR)

(21) Appl. No.: 12/708,610

(22) Filed: Feb. 19, 2010

(30) Foreign Application Priority Data
Jan. 29, 2010 (KR) 10-2010-0008330

(51) Int. Cl. H04N 7/18

(52) U.S. Cl. 348/131; 348/E07.091

(57) ABSTRACT

The present invention relates to an apparatus for detecting particles on a flat glass, which detects particles adhered to the flat glass having both sides such as a surface A and a surface B, comprising: a surface A laser light irradiating device for irradiating laser light of a first wavelength polarized in a direction S at a first angle based on a surface A normal vector toward the surface A in an upper part of the surface A of the flat glass; a surface A photographing device for taking a picture of a point where the laser light irradiated by the surface A laser light irradiating device is irradiated on the surface A of the flat glass; a surface B laser light irradiating device for irradiating laser light of a second wavelength toward the surface A at a second angle smaller than the first angle based on the surface A normal vector in the upper part of the surface A of the flat glass, and wherein the irradiated laser light is mostly transmitted in thickness direction of the flat glass; a surface B photographing device for taking a picture of a point where the laser light irradiated by the surface B laser light irradiating device is irradiated on the surface B of the flat glass; and a detection signal processor for analyzing video images inputted from the surface A photographing device and the surface B photographing device, and deciding from which photographing device the particles are more clearly outputted, to decide on a surface to which the particles adhere.

### BACKGROUND OF THE INVENTION

1. Field of the Invention

The present invention relates to an detection apparatus for particles on the glass, and more particularly, to an apparatus for detecting particles on a flat glass, which can precisely detect particles on a surface to be deposited with a micro circuit pattern.

2. Description of the Related Art

A flat glass used in a flat display is deposited with a micro circuit pattern only on one surface thereof which is called a ‘surface A’ in the glass industry and is not deposited with a micro circuit pattern on the other surface thereof which is called a ‘surface B’ in the glass industry.

When particles are present on the surface A of the flat glass, if the micro circuit pattern is deposited over the particles, a defective proportion of the micro circuit pattern is likely to increase. Therefore, it is necessary to precisely detect whether particles are present on the flat glass (specifically, the surface A on which the micro circuit pattern is to be deposited) before depositing the micro circuit pattern.

FIG. 1 is a schematic view illustrating a conventional apparatus for detecting particles on a flat glass. In the conventional apparatus for detecting particles on a flat glass, laser light having a fine thickness is obliquely irradiated on a flat glass 30 using a laser light irradiation section 20. One portion of the irradiated laser light 31 is transmitted through the flat glass and forms transmitted laser light 35, and the other portion of the irradiated laser light 31 is reflected on the flat glass and forms reflected laser light 33. If the laser light is obliquely irradiated in such a way as to have a large angle with respect to the flat glass as shown in FIG. 1, a point where the irradiated laser light 31 reaches a surface A of the flat glass and a point where the transmitted laser light 35 reaches a surface B of the flat glass have a horizontal distance difference of δL.

By photographing particles present on the surface A using a surface A photographing device 11, only the particles present on the surface A of the flat glass can be photographed, theoretically. The principle at this time resides in that, while photographing is implemented using the surface A photographing device 11, only the laser light reached the surface A of the flat glass is scattered by particles 81 present on the surface A and is incident on the lens of the surface A photographing device 11, and the laser light reached the surface B of the flat glass is transmitted through the flat glass at a position which is separated by the horizontal distance of δL and is not incident on the lens of the surface A photographing device 11.

In the conventional apparatus for detecting particles on flat glass, only when the thickness of the used laser light is very fine, it is possible to detect only the particles present on the surface A of the flat glass. However, due to a limitation in the thickness of laser light capable of being actually used, a problem is caused in that some particles 91 present on the surface B of the flat glass are also detected.

In practice, since it is the normal to have particles adhere to both the surface B and the surface A of the flat glass, in the conventional apparatus shown in FIG. 1, if some particles present on the surface B of the flat glass are detected, it is impossible to obtain precise information for the particles present on the surface A of the flat glass using a corresponding detection result.

Also, as the thickness of the flat glass is reduced, the horizontal distance difference 6L between the point where the irradiated laser light 31 reaches the surface A of the flat glass and the point where the transmitted laser light 35 reaches the surface B of the flat glass decreases, whereby the detection result cannot but be imprecise.

Another problem is that when a transferring device of the flat glass vibrates up and down, it is more difficult to exactly decide on a surface to which the particles adhere. To solve this problem, the conventional apparatus for detecting particles on flat glass has to use expensive precise conveying equipment.

### SUMMARY OF THE INVENTION

Accordingly, the present invention has been made in an effort to solve the problems occurring in the related art, and an object of the present invention is to provide an apparatus for detecting particles on a flat glass, which can precisely detect particles adhered to a surface A of a flat glass to be deposited with a micro circuit pattern.

To accomplish the above object of the present invention, an apparatus for detecting particles on a flat glass, which detects particles adhered to the flat glass having both sides such as a surface A and a surface B, comprising: a surface A laser light irradiating device for irradiating laser light of a first wavelength polarized in a direction S at a first angle based on a surface A normal vector toward the surface A in an upper part of the surface A of the flat glass; a surface A photographing device for taking a picture of a point where the laser light irradiated by the surface A laser light irradiating device is irradiated on the surface A of the flat glass; a surface B laser light irradiating device for irradiating laser light of a second wavelength toward the surface A at a second angle smaller than the first angle based on the surface A normal vector in the upper part of the surface A of the flat glass, and wherein the irradiated laser light is mostly transmitted in thickness direction of the flat glass; a surface B photographing device for taking a picture of a point where the laser light irradiated by the surface B laser light irradiating device is irradiated on the surface B of the flat glass; and a detection signal processor for analyzing video images inputted from the surface A photographing device and the surface B photographing device, and deciding from which photographing device the particles are more clearly outputted, to decide on a surface to which the particles adhere.

As is apparent from the above description, the apparatus for detecting particles on a flat glass according to the present invention provides advantages in that, since it is possible to precisely detect on a surface to which the particles adhere, the occurrence of a defective micro circuit pattern can be decreased when manufacturing a flat display such as an LCD, an organic EL, and the like.

### BRIEF DESCRIPTION OF THE DRAWINGS

FIG. 1 is a schematic view of a conventional apparatus for detecting particles on a flat glass;

FIG. 2 is a format diagram roughly illustrating a preferred embodiment of an apparatus for detecting particles on a flat glass in accordance with the present invention;

FIG. 3 is a sectional view illustrating a portion of an A-A′ direction of FIG. 2;

FIG. 4 is a graph expressing transmittance and reflectance to an incident angle for a glass of a polarized wave S;

FIG. 5 is a waveform diagram for describing a reflecting angle and a transmitting angle to an incident angle of laser light;

FIG. 6 is a graph expressing transmittance and reflectance to an incident angle for a glass of a polarized wave P;

FIG. 7 is a waveform diagram for describing polarization P and polarization S;

FIG. 8 is an explanatory diagram for describing a process that laser light irradiated by a surface A laser irradiating device is detected by a surface A photographing device after being diffused by particles adhered to a glass substrate;

FIG. 9 is an embodiment illustrating a figure that particles adhered to a glass substrate are detected through an apparatus for detecting particles on a flat glass in accordance with the present invention, and that the detected particles are visually expressed;

FIG. 10 is an explanatory diagram for describing a fact that particles can be exactly detected by an apparatus for detecting particles on a flat glass in accordance with the present invention even though a glass substrate transferring device vertically moves; and

FIG. 11 is an explanatory diagram for describing a shape of laser light used in the present invention.

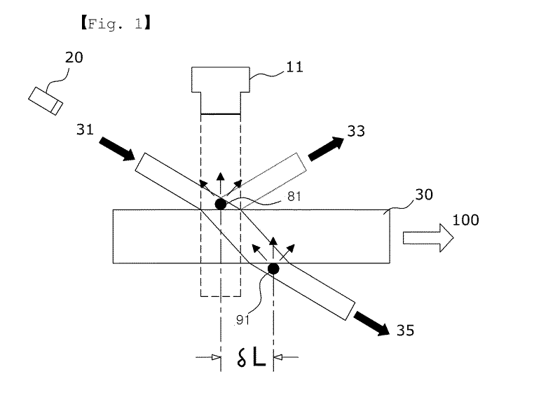

### DETAILED DESCRIPTION OF PREFERRED EMBODIMENTS

Reference will now be made in greater detail to preferred embodiments of an apparatus for detecting particles on a flat glass according to the invention, examples of which are illustrated in the accompanying drawings. Wherever possible, the same reference numerals will be used throughout the drawings and the description to refer to the same or like parts.

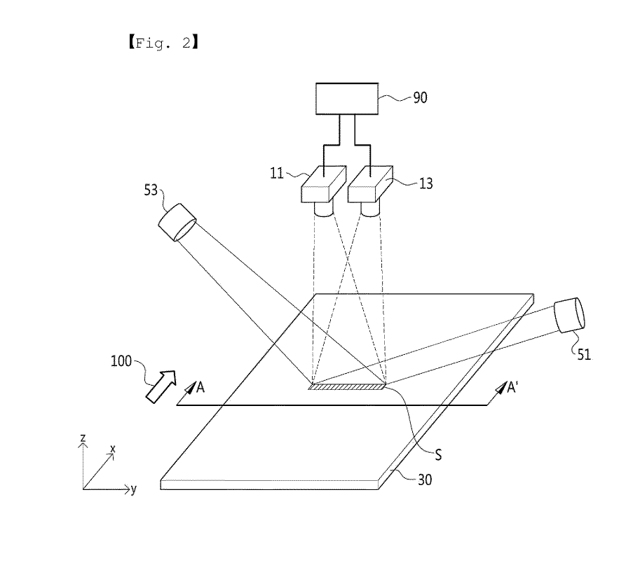

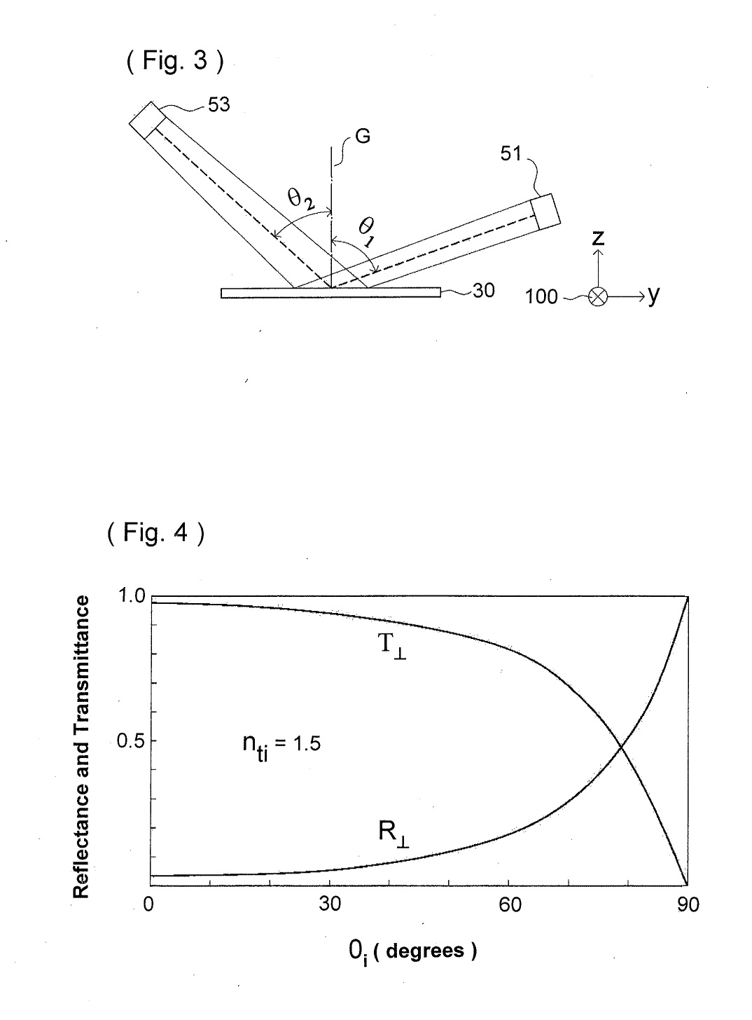

FIG. 2 is a format diagram roughly illustrating a preferred embodiment of an apparatus for detecting particles on a flat glass in accordance with the present invention, and FIG. 3 is a sectional view illustrating a portion of an A-A′ direction of FIG. 2.

Before explanation, each one side where a surface A laser light irradiating device 51 and a surface B laser light irradiating device 53 are individually equipped is defined to indicate edges positioned in transferring direction of a flat glass substrate 30 side by side, among four edges of the flat glass substrate 30 formed in rectangular shape.

Referring to FIG. 2 and FIG. 3, the apparatus for detecting particles on the flat glass comprises: the surface A laser light irradiating device 51 for irradiating laser light of a first wavelength polarized in a direction S toward a surface A on one upper side of the flat glass substrate 30; a surface A photographing device 11 for receiving laser light diffused by particles present on the surface A; the surface B laser light irradiating device 53 for irradiating laser light of a second wavelength on a surface B from a side of the flat glass substrate 30; a surface B photographing device 13 for receiving laser light diffused by particles present on the surface B; and a detection signal processor 90 for deciding to which one of surfaces A and B the corresponding particles adhere, based on image signals inputted from the surface A photographing device 11 and the surface B photographing device 13.

The glass substrate 30 is made of a thin glass material used for a panel of a display device such as an LCD, being generally formed in a thickness of 0.5 mm to 0.7 mm. The surface A means a surface to be deposited with a micro circuit pattern, while the surface B indicates a surface where the micro circuit pattern is not formed. A reference number “100” shows a transferring direction of the glass substrate 30, and a symbol S indicates an area where the laser light irradiated by the surface A laser light irradiating device 51 and the surface B laser light irradiating device 53 is irradiated on the surface A of the glass substrate 30.

It is desirable that the laser light irradiated on the surfaces A and B of the glass substrate by the laser light irradiating devices 51 and 53 roughly has a thickness of 0.65 mm to 0.95 mm in a width of 100 mm. At this time, width (approx. 100 mm) of the laser light is appropriate for the glass substrate 30 having a width of 1 mm, approximately. As the glass substrate gets bigger, the width of the laser light should be larger accordingly.

For instance, if the process glass substrate 30 has a width of more than 1 m, it is better to use laser light of more than 100 mm in width. And, if the process glass substrate 30 is in less than 1 m of width, it is desirable that the laser light has a width of less than 100 mm.

Since the surface A laser light irradiating device 51 resides in detecting particles adhered to the surface A of the glass substrate 30, it is desirable that the laser light outputted from the surface A laser light irradiating device 51 is reflected without being transmitted through the flat glass substrate 30 as possible. Because of this, it is better to maintain a first angle near to 90 degrees as possible, given that an angle between the laser light irradiated from the surface A laser light irradiating device 51 and a surface A normal vector G of the glass substrate 30 is defined the “first angle (θ1 of FIG. 3).

FIG. 4 is a graph expressing transmittance and reflectance to an incident angle for a glass of a polarized wave S. Like shown in FIG. 4, when laser light irradiated from the surface A laser light irradiating device 51 is incident as being angled at 75 degrees (i.e. θ1=75 degrees) with the surface A normal vector, it is noted that about 45% of incident light is reflected. Light irradiated on the surface A from the surface A laser light irradiating device 51 is reflected on two borders including a border where the light reaches the surface A in the air and a border where the light transmitted through the surface A reaches the surface B. Hence, theoretically, when θ1 becomes 75 degrees, it is noted that about 65% of incident light is reflected. The inventor of the present invention has known that if the above reflectance was to be accomplished, it was possible to apply the above theory to substantial particle detection on the surface A. More desirably, if the incident first angle θ1 is maintained at equal or more than 80 degrees and to be equal to or smaller than 90 degrees, more than 85% of reflectance can be maintained. Therefore, particle detection on the surface A can be more efficiently carried out.

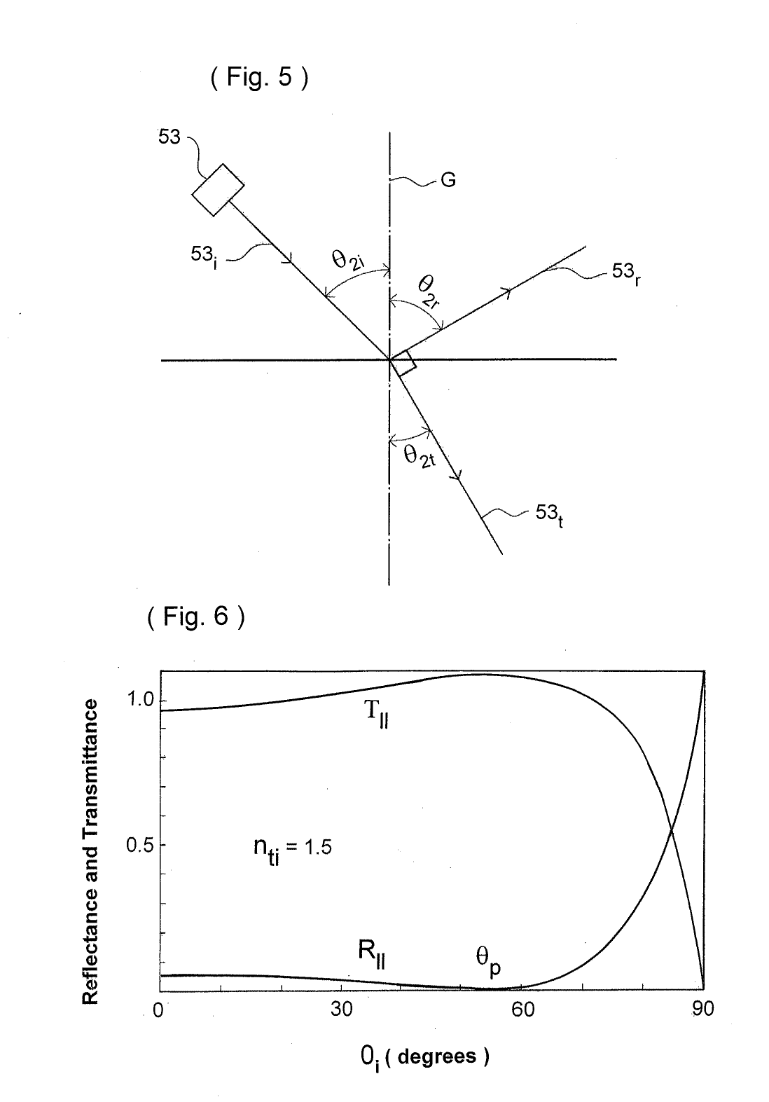

The surface B laser light irradiating device 53 is a device for irradiating laser light in order to detect particles adhered to the surface B of the glass substrate 30. Like shown in FIG. 5, if laser light irradiated by the surface B laser light irradiating device 53 is incident at an angle θ2i as incident light 53i, a portion of the incident light 53i forms transmitted light 53t at an angle θ2t, and the rest thereof forms reflected light 53r at an angle θ2r. More exactly, though there exists little light absorbed into the glass substrate 30, this light is ignored since it is too little. When the light is irradiated by using the surface B laser light irradiating device 53 on an upper side of the surface A like shown in FIG. 2, it is desirable that laser light outputted from the surface B laser light irradiating device 53 is transmitted in thickness direction of the flat glass substrate 30 as possible. Thus, given that an angle between the laser light irradiated by the surface B laser light irradiating device 53 and the surface A normal vector G of the glass substrate 30 is defined ‘second angle (θ2 of FIG. 3), it is better to maintain the second angle near to 0 degree as possible. If polarized light is not used as laser light for the surface B, it is desirable to set the second angle θ2 at equal or less than 40 degrees, by experiment, and more desirably, at equal or less than 10 degrees.

It is known that, if unpolarized laser light is irradiated on a glass, transmittance and reflectance to an incident angle are similar to those in the graph of FIG. 4, and that if θ2 is at 40 degrees, about 85% of incident light is transmitted, then if θ2 is at 10 degrees, about 97% of incident light is transmitted.

FIG. 6 is a graph expressing transmittance and reflectance to an incident angle for a glass of a polarized wave P. Like shown in FIG. 6, if the polarized wave P is used as laser light irradiated from the surface B laser light irradiating device 53, when the light is incident as forming 70 degrees (i.e. θ2=70 degrees) with the surface A normal vector, it is noted that about 90% of incident light is transmitted. Accordingly, theoretically, it is noted that more than about 90% of incident light is transmitted if the second angle θ2 is maintained at equal or less than 70 degrees, and the inventor of the present invention has known that if the above transmittance was to be accomplished, it was possible to apply the above theory to substantial particle detection on the surface B.

It is more desirable that the laser light emitted from the surface B laser light irradiating device 53 is formed as laser light of a second wavelength polarized in a direction P, and that the laser light is incident at a Brewster angle. When the light polarized in the direction P is incident on the glass substrate 30 at the Brewster angle, the light is transmitted 100% without creating a reflected wave. Referring to FIG. 6, it is noted that the Brewster angle is made in the vicinity of 55 degrees, approximately.

Besides, it is better that the surface A photographing device 11 and the surface B photographing device 13 comprise a filter which passes only the first wavelength and a filter which transmits only the second wavelength, respectively.

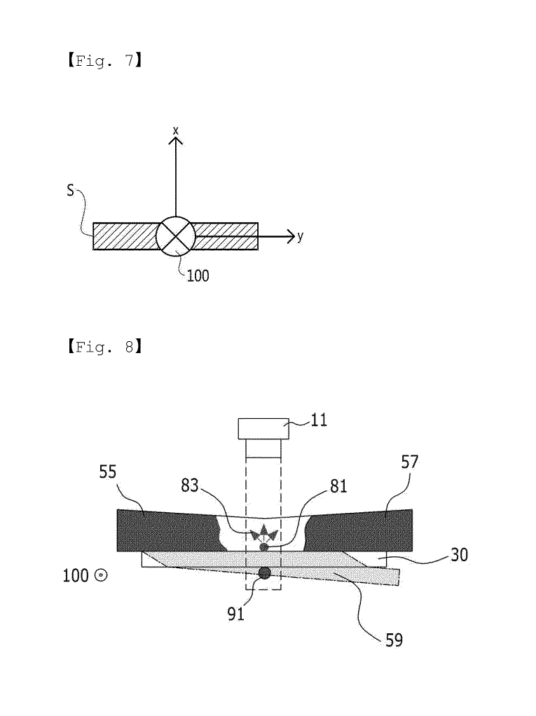

Now, polarized directions P and S will be described as follows. Through progressed light, a magnetic field and an electric field having a sine wave shape are formed in a direction vertical to the progressed light. A direction in which the electric field is formed is generally defined a polarized direction. The polarized direction will be described in reference to FIG. 7. Given that a surface where laser light in certain width and thickness reaches a ground surface as progressing in entering direction toward the ground surface is “S”, if the electric field is formed in y-axis direction, it is called polarization P, and called polarization S if the electric field is formed in x-axis direction. Referring to FIG. 2, if laser light irradiated from the surface A laser light irradiating device 51 forms an electric field on a surface parallel to an area S irradiated on the surface A of the flat glass substrate 30, it is called polarization P, and called polarization S if the electric field is formed on a surface vertical to the area S.

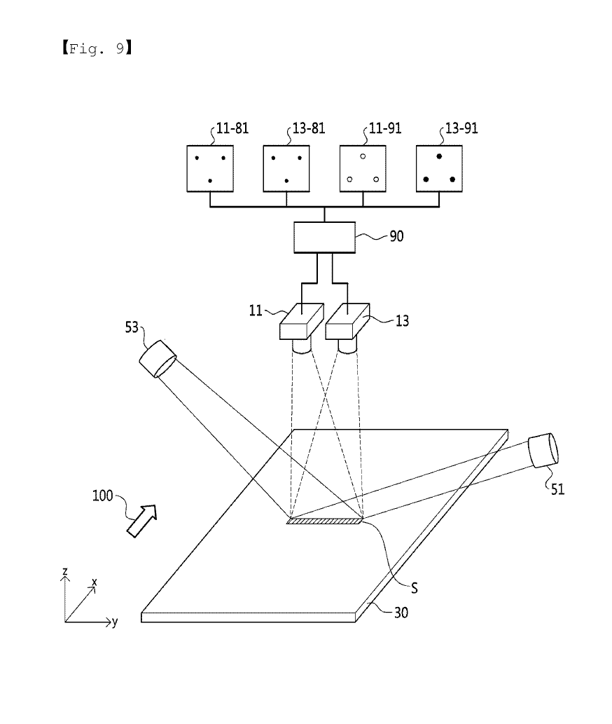

FIG. 8 is an explanatory diagram for describing a process that laser light irradiated by a surface A laser irradiating device is detected by a surface A photographing device after being diffused by particles adhered to a glass substrate, and FIG. 9 is an embodiment illustrating a figure that particles adhered to a glass substrate are detected through an apparatus for detecting particles on a flat glass in accordance with the present invention, and that the detected particles are visually expressed. Before explanation, functions of the apparatus for detecting particles on a flat glass of the present invention will be described with an assumption that surface A particles 81 and surface B particles 91 are adhered to a surface A and a surface B of a glass substrate. An incident beam 55 irradiated on the surface A of the glass substrate 30 by surface A laser light is mostly reflected to form a reflected beam 57 after reaching the surface A, and a remaining small amount of the incident beam forms a transmitted beam 59 which is transmitted through the glass substrate 30.

From now on, detailed methods of detecting particles present on the glass substrate and perceiving on which side of the glass substrate the detected particles are present will be described in reference to FIG. 8 and FIG. 9. When laser light irradiated by the surface A laser light irradiating device is irradiated on the surface A particles 81, a portion of the reflected beam 57 or the incident beam 55 of the surface A laser light is diffused by the surface A particles 81 at random angle, and the diffused beam is received in a surface A photographing device 11 disposed on top of the glass substrate 30. ‘11-81’ of FIG. 9 indicates a particle detection image screen on which the surface A photographing device 11 senses and displays the surface A laser light diffused and reflected by the surface A particles 81 of the glass substrate 30. Like shown in the drawing, as much diffused and reflected light is produced, a detected image can be more clearly displayed to visually show to an operator that the particles 81 are present on the surface A of the glass substrate 30.

Since the surface A laser light is mostly reflected on the surface A even though some of the transmitted surface A laser light reaches the surface B particles 91, a relatively small amount of the surface A laser light reaches on the surface B particles 91, whereby there is little influence (i.e. diffusion and reflection). As a result, an image screen (‘11-91’ of FIG. 9) generated based on an image signal detected by the surface A photographing device 11 is displayed in entirely dark blank state or in unclear image type due to a very low resolution of an image of detected particles. Substantially, since the surface A photographing device 11 takes one sheet of a video image, clearly taken surface A particles and blurred surface B particles taken with a relatively small lightness are displayed on the corresponding video image.

Now, the surface B particles 91 adhered to the surface B of the glass substrate 30 will be described as follows. When the surface B laser light irradiated by the surface B laser light irradiating device 53 reaches the surface A particles 81, diffusion and reflection occur for all of the incident light. Thus, the surface A particles' image (‘13-81’ of FIG. 9) taken by the surface B photographing device 13 is clearly shown. Meanwhile, if a laser light irradiation area irradiated by the surface B laser light irradiating device 53 reaches the surface B particles 91 adhered to the surface B of the glass substrate 30, the surface B laser light is mostly diffused by the surface B particles 91 at random angle, and the diffused light is received in the surface B photographing device 13 disposed on top of the glass substrate 30. ‘13-91’ of FIG. 9 shows a particle detection image screen on which the surface B photographing device 13 senses and displays the surface B laser light diffused and reflected by the particles 91 adhered to the surface B of the glass substrate 30. Substantially, since the surface B photographing device 13 takes one sheet of a video image, clearly taken surface A particles and clearly taken surface B particles are displayed on the corresponding video image.

The detection signal processor of the present invention can detect to which side the corresponding particles adhere, by using clearness of the respective particles displayed on the video image taken by the surface A photographing device and the video image taken by the surface B photographing device.

A method of detecting the surface A particles 81 and the surface B particles 91 in accordance with the present invention will be quantitatively described as follows, with an assumption that a first frequency laser beam polarized in a direction S is incident by the surface A laser light irradiating device 51 as maintaining 80 degrees with a surface A normal vector and a second frequency laser beam polarized in a direction P is incident by the surface B laser light irradiating device 53 as maintaining a Brewster angle with the surface A normal vector. At this point, it is supposed that the surface A laser light and the surface B laser light have an incident amount of 100, reflectance of the surface A laser light being reflected to the air is 85%, transmittance of the surface B laser light is 100%, and the light which reaches the particles is diffused 100%.

TABLE 1

| | Surface A particles | Surface B particles |
|---|---|---|
| Surface A laser light | 100 | 15 |
| Surface B laser light | 100 | 100 |
| Total of lightness for | 200 | 115 |
| particles on each side | | |

In this case, like shown in Table 1, while the surface A particles are diffused 100% by the surface A laser light irradiated by the surface A laser light irradiating device, only 15% of the surface B particles is diffused. In comparison, provided that a focus of the surface B photographing device is equally recognized on the surfaces A and B, the surface B laser light irradiated by the surface B laser light irradiating device is transmitted on the surface B 100% after being irradiated on the surface A, which means that 100% of diffusion occurs for both of the surface A particles and the surface B particles. Therefore, while lightness diffused for the surface A particles detected by the surface A photographing device and the surface B photographing device is 200% in total, overall lightness diffused for the surface B particles detected by the surface A photographing device and the surface B photographing device is 115%. The detection signal processor detects whether the respective particles are present on the surface A or the surface B, by comparing the video image taken by the surface A photographing device and the video image taken by the surface B photographing device.

If it is hard to detect the particles through comparison in Table 1, detection can be more easily done by setting strength of the surface A laser light to be larger than that of the surface B laser light by double. Provided that the surface A laser light has an incident amount of 200 and the surface B laser light has an incident amount of 100, reflectance of the surface A laser light being reflected to the air is 85%, transmittance of the surface B laser light is 100%, and the light which reaches the particles is diffused 100%, values of Table 1 will be changed as shown in Table 2.

TABLE 2

| | Surface A particles | Surface B particles |
|---|---|---|
| Surface A laser light | 200 | 30 |
| Surface B laser light | 100 | 100 |
| lightness for | 300 | 130 |
| particles on each | | |
| side | | |

Like shown in Table 2, if the surface A laser light irradiating device and the surface B laser light irradiating device have different output quantities, lightness differences in accordance with locations of the particles are more clearly shown. Accordingly, the detection signal processor can more easily detect to which side the corresponding particles adhere, by using a total sum of diffused lightness of the corresponding particles received from the surface A photographing device and the surface B photographing device.

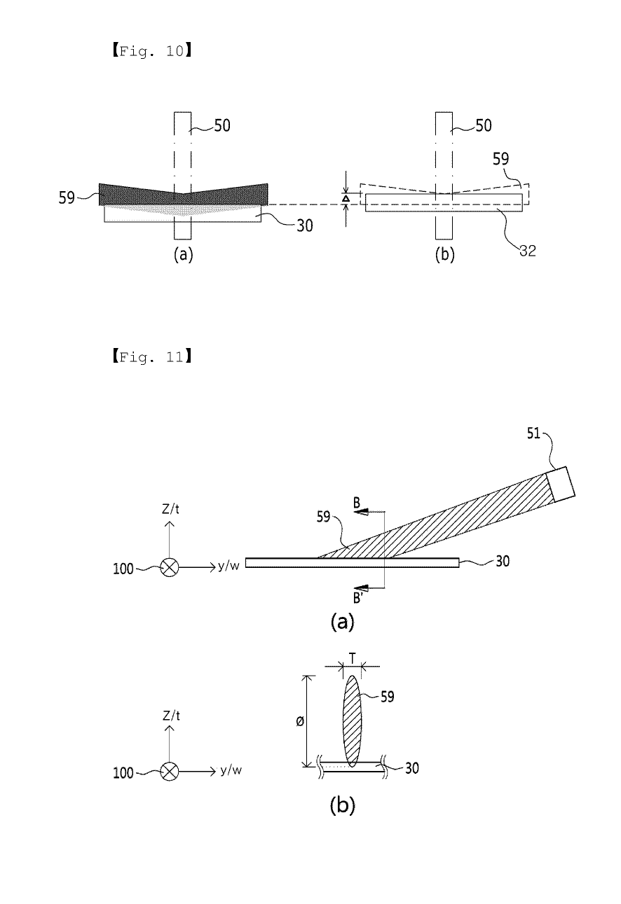

FIG. 10 is an operational diagram for illustrating a principle of exactly detecting particles on a glass surface regardless of changes of flatness of a glass substrate 30.

FIG. 10(a) illustrates that the transferred glass substrate 30 is being flatly transferred at a normal position. A glass substrate 32 shown in FIG. 10(b) is the glass substrate whose flatness is changed, indicating that the glass substrate is being transferred while its flatness is changed as much as ‘Δ’ toward an upper part from the normal position. In addition, an area irradiated on an upper part of the glass substrate by surface A detection camera 11 is presented as a reference number ‘50’.

A prior apparatus for detecting particles on a glass surface has a problem that detective precision of particles attached to the glass substrate 30 gets more deteriorated since it does not properly cope with changes of flatness of the glass substrate 30, which occurs while the substrate is being transferred like above.

However, the apparatus for detecting particles on a glass surface in accordance with the present invention can minimize influence caused by changes of flatness of the substrate 30 during detection of the particles, because the laser beam 59 is irradiated vertically to transferring direction of the glass substrate 30.

More specifically, by referring to FIGS. 10 (a) and (b), a detecting process for surface A particles 81 will be described as follows. Even though the glass substrate 30 reaching the area where the surface A laser beam 59 is irradiated is positioned at a higher position (that is, position ‘32’ of the glass substrate) by being upward-bent as much as ‘Δ’ from a perfectly flat position (that is, position ‘30’ of the glass substrate), the upper side of the glass substrate 32 is still maintained in a state of being included in the inside of the surface A laser beam 59, and accordingly, diffusion and reflection caused by the particles attached to the upper side of the glass substrate 30 can be also performed normally, resulting in an exact detection of the particles.

It is because, in the apparatus for detecting particles on a glass surface in accordance with the present invention, the surface A laser beam 59 is irradiated in a direction vertical to the transferring direction of the glass substrate 30 while the surface A laser beam 59 is diagonally incident as forming a predetermined inclination angle from the upper side of the glass substrate 30, which can allow the upper side of the glass substrate 32 to be always included in the inside in width direction of the laser beam even though changes of flatness occur as much as ‘Δ’ on the transferred glass substrate 30.

FIG. 11 is a diagram for illustrating the shape of a laser beam used in the present invention. Like shown in FIG. 11(a), a laser beam 59 is being irradiated on a side of an upper side of the glass substrate 30 which is being transferred to a front side of the drawing, and FIG. 11(b) shows an A-A′ sectional view of FIG. 11(a).

Like shown in FIG. 11(b), a laser beam 59 irradiated by the laser beam radiation device in accordance with this invention has an oblong shape of a small thickness (T) in width direction (w) of the glass substrate (30) and of a broad width (Φ) in thickness direction (t).

By using such a laser shape, it is possible to exactly detect on which surface the particles are presented on the glass substrate 30 even though a relatively low-priced transferring device whose flatness is not regular is employed.

Although preferred embodiments of the present invention have been described for illustrative purposes, those skilled in the art will appreciate that various modifications, additions and substitutions are possible, without departing from the scope and the spirit of the invention as disclosed in the accompanying claims.

1. An apparatus for detecting particles on a flat glass, which detects particles adhered to the flat glass having both sides such as a surface A and a surface B, comprising:
a surface A laser light irradiating device for irradiating laser light of a first wavelength polarized in a direction S at a first angle based on a surface A normal vector toward the surface A in an upper part of the surface A of the flat glass;
a surface A photographing device for taking a picture of a point where the laser light irradiated by the surface A laser light irradiating device is irradiated on the surface A of the flat glass;
a surface B laser light irradiating device for irradiating laser light of a second wavelength toward the surface A at a second angle smaller than the first angle based on the surface A normal vector in the upper part of the surface A of the flat glass, and wherein the irradiated laser light is mostly transmitted in thickness direction of the flat glass;
a surface B photographing device for taking a picture of a point where the laser light irradiated by the surface B laser light irradiating device is irradiated on the surface B of the flat glass; and
a detection signal processor for analyzing video images inputted from the surface A photographing device and the surface B photographing device, and deciding on a surface to which the particles adhere.

2. The apparatus for detecting particles on a flat glass of claim 1, wherein a filter for selectively transmitting the first wavelength is comprised in the surface A photographing device, while a filter for selectively transmitting the second wavelength is comprised in the surface B photographing device.

3. The apparatus for detecting particles on a flat glass of claim 1, wherein the first angle is equal or more than 75 degrees.

4. The apparatus for detecting particles on a flat glass of claim 3, wherein the first angle is equal or more than 80 degrees.

5. The apparatus for detecting particles on a flat glass of claim 1, wherein the surface B laser light irradiating device is for the laser beam of the second wavelength polarized in the direction P.

6. The apparatus for detecting particles on a flat glass of claim 5, wherein the second angle is a Brewster angle.

7. The apparatus for detecting particles on a flat glass of claim 5, wherein the second angle is equal or more than 70 degrees.

8. The apparatus for detecting particles on a flat glass of claim 1, wherein the laser light irradiated from the surface A laser light irradiating device and the surface B laser light irradiating device has a width (φ) defined in thickness direction of the glass substrate and a thickness (T) defined in width direction of the glass substrate, and the laser light is in oblong shape where the width (φ) is larger than the thickness (T).

9. The apparatus for detecting particles on a flat glass of claim 1, wherein the second angle is maintained at equal or less than 40 degrees by exceeding zero degree.
